(19) United States
(12) Patent Application Publication
(10) Pub. No.: US 2026/0105382 A1
(43) Pub. Date: Apr. 16, 2026

(54) DYNAMIC OPERATOR DISPATCH MODE FOR IMPLEMENTING MACHINE-LEARNING MODELS

(71) Applicant: XILINX, INC., San Jose, CA (US)

(72) Inventors: Tejus Siddagangaiah, Broomfield, CO (US); Abid Karumannil, Kerala (IN); Ashish Sirasao, San Jose, CA (US); Satyaprakash Pareek, San Jose, CA (US); Mohammed Bader Alam, San Jose, CA (US)

(21) Appl. No.: 18/911,958

(22) Filed: Oct. 10, 2024

(51) Int. Cl. G06N 20/10

(52) U.S. Cl. CPC G06N 20/10

(57) ABSTRACT

To enable an accelerator unit to perform one or more operators for a machine-learning model, a processing system is configured to generate a launch kernel using a dynamic operator dispatch mode. For example, a processing unit of the processing system first organizes an operator group of the machine-learning model into a series of nodes that represents the operators in the operator group. Based on this series of nodes, the processing unit retrieves and modifies pre-compiled operators from an operator library stored in a memory of the processing system. The processing unit then generates a launch kernel based on the modified pre-compiled operators.

### BACKGROUND

Some processing systems run applications that require the use of one or more machine-learning models that each include sets of operators to be performed. To perform these sets of operators, the processing systems are configured to generate and execute kernels that allow certain components of the processing system to perform the sets of operators for the machine-learning models. Further, such processing systems implement different operation execution modes such as eager mode or graph mode to generate these kernels. During eager mode, as an example, a processing system generates and executes a corresponding kernel for each operator to be performed. During a graph mode, as another example, a processing mode first arranges each operator to be performed into a graph. The processing mode then maps this graph to one or more components of the processing system. From this mapped graph, the processing system generates a single kernel for all the operators to be performed.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a processing system implementing a dynamic operator dispatch mode for the implementation of machine-learning models, in accordance with some implementations.

FIG. 2 is a diagram of an example operation for retrieving and modifying hardware-modified operators for an operator group, in accordance with some implementations.

FIG. 3 is a block diagram of a series of nodes generated from an operator group, in accordance with some implementations.

FIG. 4 is a flow diagram illustrating an example method for generating and executing a launch kernel in a dynamic operator dispatch mode, in accordance with some implementations.

### DETAILED DESCRIPTION

Systems and techniques disclosed herein include a processing system configured to execute one or more applications that require the implementation of one or more machine-learning models such as large-language models (LLMs), supervised learning models, unsupervised learning models, reinforcement learning models, neural networks, deep-learning models, generative artificial intelligence (AI), and the like. To facilitate the implementation of these machine-learning models, the processing system further includes an accelerator unit (AU) configured to perform one or more operators required for the machine-learning models such as matrix multiplication operators (e.g., MATMULs), if operators, sigmoid linear unit (SILU) operators, and the like. Before the AU is enabled to perform these operators, a processing unit of the processing system, such as a central processing unit (CPU), is configured to generate and run a kernel that includes a series of instructions representing the operators to be performed by the AU. For example, the processing unit first allocates portions of system memory (e.g., buffers) to the AU for the performance of the operators indicated in a kernel and stores data (e.g., operands, variables, look-up tables (LUTs), register files) used in the performance of the operators in the allocated buffers. After storing this data, the processing unit executes the kernel which includes sending the series of instructions indicated in the kernel to the AU. The AU then executes this series of instructions which causes the AU to perform the corresponding operators using the data stored in the allocated buffers and store the resulting data in one or more allocated output buffers. After storing these results, the AU provides an interrupt to the processing unit indicating that the results are available. The processing unit then reads the results from the output buffers. However, first generating and running this kernel before the processing unit is able to read the results of the operators from the output buffers introduces an overhead that increases the time needed to perform the machine-learning model. For example, the processing unit issuing a series of instructions to the AU based on a kernel, the AU parsing and executing the instructions and begins execution, the AU providing an interrupt to the processing unit, and the processing unit processing the interrupt each increases the amount of time before the processing unit is able to read the results of the operators.

As such, systems and techniques disclosed herein are directed toward reducing the overhead created by running a kernel for the implementation of machine-learning models. That is, systems and techniques disclosed herein are directed toward reducing the time before the results of the operators of a machine-learning model are available in an output buffer. For example, to help reduce the overhead of running kernel, the processing unit of the processing system is configured to generate launch kernels for a machine-learning model in a dynamic operator dispatch mode. During this dynamic operator dispatch mode, the processing unit is configured to first receive operator groups (e.g., subgraphs) to be performed for a machine-learning model. These operator groups, for example, include data indicating which operators are to be performed, inputs for the operators, and outputs for the operators. From an operator group, the processing unit produces a series of nodes (e.g., linear series of nodes) which includes sequentially arranged nodes each representing an operator of the operator group. As an example, from an operator group, the processing unit produces a series of nodes that includes a first node to be performed representing a first operator from the operator group, a second node to be performed after the first node representing a second operator of the operator group, and a third node to be performed after the second node representing a third operator of the operator group. Further, this series of nodes indicates which outputs of respective nodes are provided to corresponding other nodes as inputs. As an example, the series of nodes indicates that an output of a first node to be performed is provided to a third node to be performed. From this series of nodes, the processing unit determines operator group metadata for the operators in the operator group from which the series of nodes was generated. This operator group metadata, for example, indicates a list of the operators, buffer offsets for the operators, data types used by the operators, or any combination thereof in the operator group from which the series of nodes was generated.

For each operator in the operator list of the operator group metadata, the processing unit retrieves a corresponding operator from an operator library stored, for example, in the system memory of the processing system. This operator library includes program code indicating one or more precompiled operators previously modified based on the hardware of the AU. For example, the operator library includes program code indicating precompiled operators that have each one or more parameters (e.g., data types, weights, matrix sizes) modified to increase the performance of the operator on the hardware of the AU. Such program code indicating precompiled operators previously modified based on the hardware of the AU are also referred to herein as “hardware-modified operators.” Each hardware-modified operator, for example, also indicates one or more parameters such as one or more inputs (e.g., input 1, input 2) for the operator, one or more outputs for the operator, data (e.g., variables, look-up tables, operands, register files) used by the operator, and intermediate buffer ordering for the operator.

After retrieving a hardware-modified operator for each operator in the operator list indicated by the operator group metadata, the processing unit then modifies the retrieved hardware-modified operators based on the operator group metadata. For example, for each node of the series of nodes, the processing unit first determines operator requirements for the hardware-modified operator corresponding to the node based on the operator group metadata associated with the hardware-modified operator (e.g., operator group metadata associated with the same operator). Such operator requirements, for example, include data indicating the buffer size needed to perform the hardware-modified operator. Additionally, the processing unit modifies the inputs of one or more retrieved hardware-modified operators based on the series for nodes, operator group metadata, or both. For example, based on the position of a node within the series of nodes, the positions of other nodes within the series of nodes, or both, the processing unit modifies one or more inputs of the hardware-modified operator corresponding to that node.

As an example, the processing unit modifies one or more inputs of a hardware-modified operator to point to the outputs of one or more other hardware-modified operators corresponding to one or more other nodes of the series of nodes. After modifying the inputs of one or more hardware-modified operators, the processing unit then modifies the buffer offsets used by the hardware-modified operators to ensure that any modified inputs of the hardware-modified operators point to corresponding outputs of other hardware-modified operators. Additionally, as an example, the processing unit modifies the buffer offsets of the inputs, output, or both of one or more hardware-modified operators such that at least a portion of a buffer is used to store intermediate results, final results, or both from two or more operators. That is, the processing unit modifies the buffer offsets of the hardware-modified operator to enable memory reuse such that an address in a buffer is used to store intermediate results, final results, or both of multiple operators, reducing the memory footprint of the group of operators.

After modifying one or more hardware-modified operators in this way, the processing unit produces a corresponding instruction for each node of the series of nodes. As an example, for each node, the processing unit generates an instruction based on the hardware-modified operator corresponding to the node (e.g., as modified based on its position within the series of nodes) and the corresponding operator requirements of the hardware-modified operator. After producing an instruction for each node of the series of nodes, the processing unit merges and serializes the instructions to generate a launch kernel that includes a series of instructions. Within the series of instructions of the launch kernel, the instructions are arranged such that the instructions are sequentially executed by the AU based on the arrangement of the series of nodes. For example, the instructions are arranged such that a first instruction corresponding to the first node of the series of nodes is executed first, a second instruction corresponding to the second node of the series nodes is executed second, a third instruction corresponding to the third node of the series nodes is executed third, and so on. After generating the kernel, the processing unit allocates buffers to the AU based on the series of instructions of the launch kernel and stores data (e.g., operands, register files, LUTs, variables) used by the operators indicated in the series of instructions in the allocated buffers. The processing unit executes the launch kernel and provides the series of instructions to the AU which executes the instructions in an order indicated by the series of instructions. After executing the instructions, the AU sends an interrupt to the processing unit indicating that the results of the group of operators are available in an output buffer allocated to the AU. The processing unit then reads the results and continues the execution of an application.

In this way, the processing system implementing a dynamic operator dispatch mode reduces the overhead associated with kernel execution when compared to other dispatch modes such as eager mode, graph mode, and the like. For example, within eager mode, a processing system generates a kernel for each operator and then each kernel is executed sequentially. Because a processing system in eager mode generates a kernel for each operator, the time is increased to perform the operators when compared to a processing system implementing a dynamic operator dispatch mode that allows for multiple operators to be performed using the same kernel. Further, within a graph mode, a processing system first arranges each operator to be performed into a graph and then maps the graph to the hardware architecture on which the operators are to be performed. Additionally, compiling a machine-learning model in a graph mode is not a trivial task for certain AU architectures, increasing the number of processing resources in an AU needed to compile a machine-learning model using a graph mode. As such, a processing system implementing a dynamic operator dispatch mode that uses an operator library with precompiled operators reduces the time and processing resources needed to perform the operators when compared to a processing system implementing a graph mode that maps a graph to the hardware each time a kernel is to be executed.

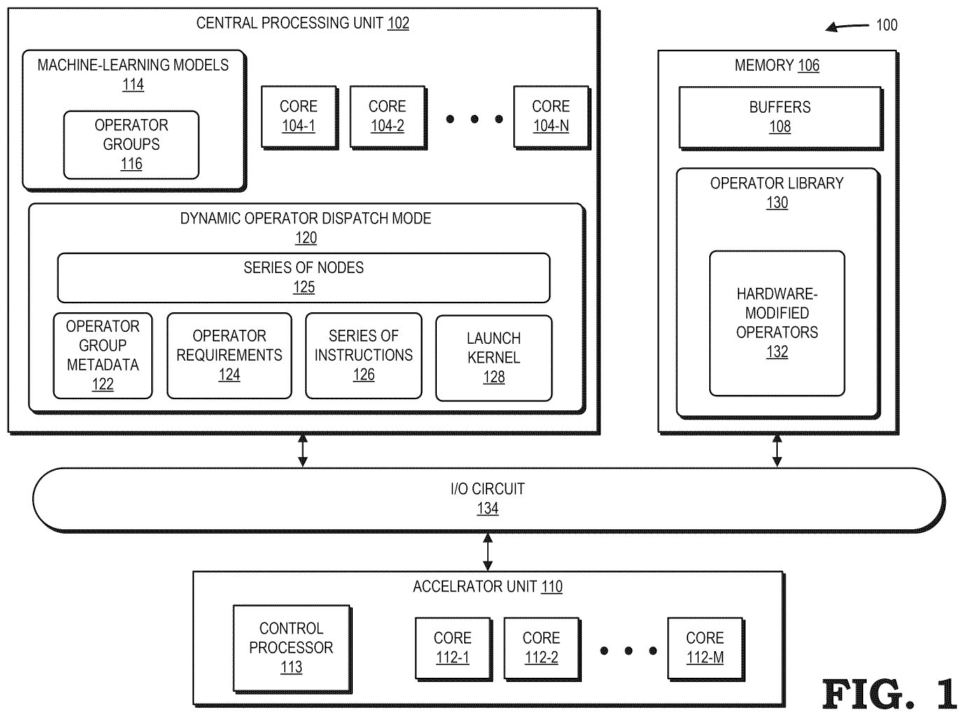

Referring now to FIG. 1, a processing system 100 implementing a dynamic operator dispatch mode for the execution of machine-learning models is presented, in accordance with implementations. In implementations, processing system 100 is configured to execute one or more applications requiring the implementation of one or more trained machine-learning models 114 such as one or more LLMs, supervised learning models, unsupervised learning models, reinforcement learning models, neural networks, deep-learning models, generative AI models, and the like. To implement these trained machine-learning models 114, processing system 100 includes AU 110 configured to perform one or more operators for the machine-learning model 114 such as matrix multiplication operators (e.g., MATMULs), if operators, SILU operators, and the like. For performing these operators, AU 110 includes one or more processor cores 112 each operating as one or more compute units (e.g., sets of single instruction, multiple data (SIMD) units) that perform the same operation for different data sets. As an example, an AU 110 is implemented as one or more vector processors, coprocessors, graphics processing units (GPUs), general-purpose GPUs (GPGPUs), neural processing units (NPUs), non-scalar processors, highly parallel processors, AI processors, inference engines, machine-learning processors, other multithreaded processing units, scalar processors, serial processors, programmable logic devices (e.g., field-programmable logic devices (FPGAs)), or any combination thereof. Though the example implementation presented in FIG. 1 shows AU 110 as including three processor cores (112-1, 112-2, 112-M) representing an M integer number of processor cores (where M>0), in other implementations, AU 110 may include any non-zero integer number of processor cores 112. Further, to enable communication between AU 110 and one or more other components (e.g., CPU 102, memory 106) of processing system 100, processing system 100 includes input/output (I/O) circuit 134. I/O circuit 134 includes, for example, one or more busses, switches (e.g., PCI switches), data fabrics, queues, buffers, or the like. As an example, in implementations, I/O circuit 134 is configured to connect the control processor 113 of AU 110 to one or more processor cores 104 of CPU 102.

To enable AU 110 to perform operators for a trained machine-learning model 114, processing system 100 includes CPU 102 configured to allocate buffers 108 to AU 110, set up buffers 108 for AU 110, provide instructions to AU 110, read results produced by AU 110, or any combination thereof. Such a CPU 102, for example, implements one or more processor cores 104 that execute instructions, operations, or both for one or more applications requiring trained machine-learning models 114 concurrently or in parallel. Though the example implementation presented in FIG. 1 shows CPU 102 as including three processor cores 104-1, 104-2, 104-N represented an N integer number of processor cores (where N>0), in other implementations, CPU 102 may include any number of processor cores 104. In implementations, to enable AU 110 to perform operators for a trained machine-learning model 114, CPU 102 first allocates one or more portions of memory 106 to AU 110 to be used for storing data (e.g. operands, register files, instructions) used in the performance of one or more operators, data resulting from the performance of one or more operators (e.g., results), or both based on the operators to be performed by AU 110 for a trained machine-learning model 114. For example, based on the operators to be performed by AU 110, CPU 102 allocates one or more buffers 108 to AU 110 each formed from a least a portion (e.g., range of addresses) of memory 106. Memory 106, for example, is implemented using a non-transitory computer-readable medium, for example, a dynamic random-access memory (DRAM). In some implementations, memory 106 is implemented using other types of memory including, for example, static random-access memory (SRAM), nonvolatile RAM, and the like.

After allocating one or more buffers 108 to AU 110, CPU 102 executes a launch kernel 128 which includes a series of instructions to be performed by AU 110.

For example, based on executing the launch kernel 128, CPU 102 provides a series of instructions indicated in the launch kernel 128 to AU 110. In response to receiving the series of instructions, a control processor 113 of AU 110 parses and schedules the instructions in the series of instructions for execution by the compute units (e.g., processor cores 112 functioning as compute units) of AU 110. Such a control processor 113, for example, includes circuitry (e.g., microprocessors, processor cores 112, microcontrollers, programmable logic devices, caches, memories) configured to schedule one or more received instructions by providing data indicating (e.g., pointers to) one or more operators, operands, instructions, variables, register files, or any combination thereof to one or more compute units used in the execution of the instructions. AU 110 then executes the scheduled instructions and stores data resulting from the execution of the instructions (e.g., results) in one or more buffers 108 (e.g., output buffers) allocated to the AU 110. After the results are stored in one or more buffers 108, AU 110 provides an interrupt to CPU 102 indicating that execution of the operators has been completed. In response to receiving this interrupt, CPU 102 retrieves the results from the buffers 108.

However, by CPU 102 running such a launch kernel 128, an overhead is introduced into the implementation of the trained machine-learning model due to the time needed between the launch kernel 128 being run by CPU 102 and AU 110 providing an interrupt to CPU 102 indicating that results of the instructions indicated in the launch kernel 128 are available. To help reduce this overhead associated with running a launch kernel 128, CPU 102 is configured to generate a launch kernel 128 using a dynamic operator dispatch mode 120. During this dynamic operator dispatch mode 120, CPU 102 first determines one or more operator groups 116 of a trained machine-learning model 114 to be performed. As an example, an application executed by CPU 102 includes program code indicating one or more operator groups 116 of a machine-learning model 114 that is to be implemented for the application. These operator groups 116, for example, include data (e.g., subgraphs) indicating which operators are to be performed for a trained machine-learning model 114, inputs for the operators, and outputs for the operators. For each operator group 116, CPU 102 generates a series of nodes 125 that includes sequentially arranged nodes each representing an operator of the operator group 116. As an example, CPU 102 generates a series of nodes 125 including nodes each indicating a corresponding operator of an operator group 116 and arranged in the order in which they are to be performed. That is, a series of nodes 125 includes a first node representing a first operator of an operator group 116 to be performed first, a second node representing a second operator of the operator group 116 to be performed second, a third node representing a third operator of the operator group to be performed third, and so on. Further, a generated series of nodes 125 indicates which outputs of respective nodes (e.g., outputs of operators represented by the nodes) are provided to corresponding other nodes (e.g., other operators represented by other nodes) as inputs. As an example, a series of nodes 125 indicates that an output of a first node to be performed first is provided to a third node to be performed.

From a generated series of nodes 125, CPU 102 determines operator group metadata 122 for the operator group 116 from which the series of nodes 125 was generated. This operator group metadata 122 indicates, for example, a list of operators, buffer mappings (e.g., buffer offsets, buffer sizes) for the operators, data types used by the operators, or any combination thereof in the operator group 116. As an example, based on the position of one or more nodes in the series of nodes 125, CPU 102 operator group metadata 122 indicating a list of operators, buffer mappings for the operators (e.g., buffer offsets for the operators), data types used by the operators, or any combination thereof in the operator group 116 from which the series of nodes 125 was generated. After generating the operator group metadata 122, CPU 102 retrieves a corresponding hardware-modified operator 132 from operator library 130 for each operator identified in the list of operators of the operator group metadata 122. Operator library 130, for example, includes a library within memory 106 that includes program code indicating one or more precompiled operators (e.g., hardware-modified operators 132) used in one or more machine-learning models 114. As an example, operator library 130 includes program code indicating one or more precompiled matrix multiplication operators (e.g., MATMULs), if operators, SILU operators, and the like. Further, each operator in operator library 130 includes program code for one or more operators previously modified based on hardware of AU 110 such as the number of compute units of AU 110, matrix sizes supported by the hardware of AU 110, cache sizes of AU 110, cache ways of the AU, or any combination thereof, to name a few. As an example, operator library 130 includes program code for one or more precompiled operators that had one or more parameters (e.g., data types, weights, matrix sizes) previously modified to decrease the power consumption of the operators when executed by AU 110, decrease the time needed for AU 110 to execute the operators, decrease the memory footprint of the operators on AU 110, increase the processing efficiency of the operators when executed by AU 110, or any combination thereof. The program code of precompiled operators previously modified this way and stored in operator library 130 is represented in FIG. 1 as hardware-modified operators 132. Additionally, each hardware-modified operator 132 includes data representing a corresponding operator in a format (e.g., transaction binary format) so that the operator is defined by an input, output, buffer ordering for intermediate outputs, and offsets for buffer addresses (e.g., buffer offsets).

After retrieving a corresponding hardware-modified operator 132 for each operator identified in the operator list of the operator group metadata 122, CPU 102 determines operator requirements 124 for each retrieved hardware-modified operator 132. As an example, based on the program code of a hardware-modified operator 132, operator group data 122 associated with the hardware-modified operator 132, or both, CPU 102 determines operator requirements 124 indicating a corresponding buffer size for the hardware-modified operator 132. Further, based on the positions of the nodes in the series of nodes 125, CPU 102 modifies the inputs of one or more retrieved hardware operators 132 to point to the outputs of one or more other retrieved hardware operators 132. For example, based on the output of a first node in the series of nodes 125 being provided as an input to a third node in the series of nodes 125, CPU 102 modifies an input of the hardware-modified operator 132 corresponding to the third node to point to the output of the hardware-modified operator 132 corresponding to the first node. Based on modifying the inputs of one or more retrieved hardware-modified operators 132 in this way, CPU 102 modifies the buffer offsets associated with one or more hardware-modified operators 132 to ensure that any modified inputs of the hardware-modified operators 132 point to corresponding outputs of other hardware-modified operators 132. Additionally, according to some implementations, CPU 102 modifies the buffer offsets of one or more hardware-modified operators 124 such that at least a portion of a buffer 108 is configured to store intermediate results, final results, or both from two or more hardware-modified operators 124. That is, CPU 102 modifies the buffer offsets of one or more hardware-modified operators 124 to enable memory reuse such that an address in a buffer 108 is used to store intermediate results, final results, or both of multiple hardware-modified operators 124, reducing the memory footprint of a resulting launch kernel 128.

Based on CPU 102 modifying one or more hardware-modified operators 132 based on the positions of nodes in the series of nodes 125, CPU 102 compiles the hardware-modified operators 132 by first producing one or more corresponding instructions for each hardware-modified operator 132. As an example, for each node of the series of nodes 125, CPU 102 generates one or more instructions based on the hardware-modified operator 132 corresponding to the node (e.g., as modified based on its position within the series of nodes 125) and the operator requirements 124 of the corresponding hardware-modified operator 132 corresponding to the node. CPU 102 then merges and serializes the instructions of the hardware-modified operators 132 to produce a launch kernel 128 that includes a series of instructions 126. Within the series of instructions 126, instructions are arranged such that the instructions are sequentially executed by AU 110 based on the arrangement of the nodes in the series of nodes 125. For example, the instructions in the series of instructions 126 are arranged such that a first instruction corresponding to the first node of the series of nodes is executed first, a second instruction corresponding to the second node of the series nodes is executed second, a third instruction corresponding to the third node of the series nodes is executed third, and so on. After generating the launch kernel 128, CPU 102 allocates buffers 108 to the hardware-modified operators 132 indicated in the series of instructions 126 of the launch kernel 128 based on the inputs, outputs, weights used, intermediate results (e.g., scratch memory results), and the like indicated in the instructions. CPU 102 then stores data (e.g., operands, register files, variables) used by the indicated hardware-modified operators 132 in the allocated buffers 108. After storing this data, CPU 102 executes the launch kernel 128 and provides the series of instructions 126 to AU 110. In response to receiving the series of instructions 126, AU 110 schedules and executes the series of instructions 126 using one or more compute units (e.g., processor cores 112 operating as one or more compute units). After executing the series of instructions 126, AU 110 sends an interrupt to CPU 102 indicating that the results of the operator group 116 (e.g., data resulting from the execution of the series of instructions 126) are available in a corresponding buffer (e.g., output buffer 108). CPU 102 then reads the results and continues the execution of an application.

Because processing system 100 uses dynamic operator dispatch mode 120 to generate a launch kernel 128, the overhead associated with generating and executing the launch kernel 128 is reduced when compared to other dispatch modes such as eager mode, graph mode, and the like. As an example, in an eager mode, a processing system generates a launch kernel for each operator and then each kernel is executed sequentially. However, because in dynamic operator dispatch mode 120 processing system 100 generates launch kernels 128 for operator groups 116 rather than each individual operator, fewer launch kernels 128 are executed by processing system 100. By executing fewer launch kernels 128, processing system 100 reduces the time associated with executing launch kernels 128 which reduces the overhead of the launch kernels 128 when compared to an eager mode. As another example, within a graph mode, a processing system first arranges each operator to be performed into a graph and then maps the graph to the hardware architecture on which the operators are to be performed. However, because the dynamic operator dispatch mode 120 implemented by processing system 100 uses operator library 130 to retrieve precompiled hardware-modified operators 132 rather than mapping the operators to the hardware of AU 110 each time a launch kernel is generated, the time and overhead needed to generate a launch kernel 128 is reduced when compared to a graph mode.

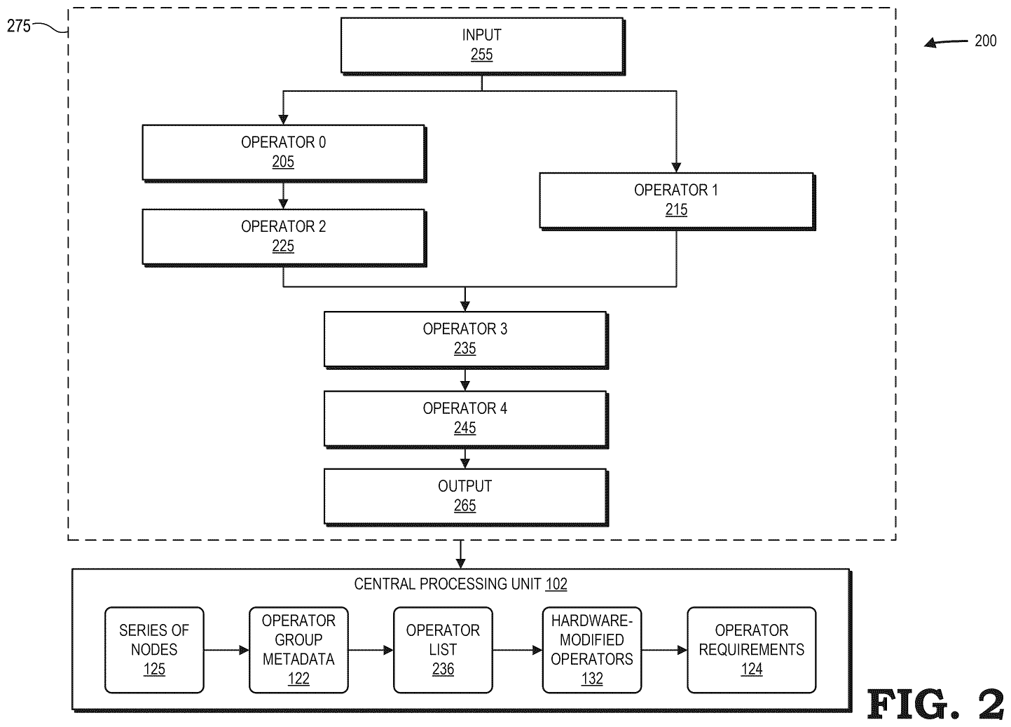

Referring now to FIG. 2, an example operation 200 for retrieving hardware-modified operators for an operator group is presented, in accordance with some implementations. In implementations, at least a portion of example operation 200 is implemented by CPU 102 while generating a launch kernel 128 using a dynamic operator dispatch mode 120. Example operation 200, in implementations, first includes CPU 102 receiving data representing an example operator group 275 of a trained machine-learning model 114 to be implemented. In implementations, example operator group 275 is implemented in processing system 100 as an operator group 116. This example operator group 275 includes data (e.g., a subgraph) indicating the operators (e.g., operators 205, 215, 225, 235, 245) to be performed for the trained machine-learning model 114, the inputs (e.g., input 255) to the example operator group 275, the output (e.g., output 265) of the example operator group 275, the inputs of the operators to be performed, the outputs of the operators to be performed, or any combination thereof. According to implementations, each operator 205, 215, 225, 235, 245 in the example operator group 275 includes a corresponding matrix multiplication operator (e.g., MATMUL), if operator, SILU operator, or the like. Referring to the example implementation presented in FIG. 2, example operator group 275 includes data first indicating an input 255 that represents one or more values, addresses, data types, or like used as an input to the operator group 225. Within this example operator group 275, the input 255 is provided to a first operator 205 (e.g., operator 0) and a second operator 215 (e.g., operator 1). Further, within this example operator group 275, the output of the first operator 205 is provided as an input to a third operator 225 (e.g., operator 2), and the output of the second operator 215 is provided as an input to a fourth operator 235 (e.g., operator 3). Additionally, the output of the third operator 225 is also provided as an input to the fourth operator 235. The output of the fourth operator 235 is then provided to a fifth operator 245 (e.g., operator 4) which produces an output 265 of the example operator group 275 based on the output of the fourth operator 235. Though the implementation presented in FIG. 2 shows example operator group 275 as including five operators (205, 215, 225, 235, 245), in other implementations example operator group 275 can include any non-zero integer number of operators.

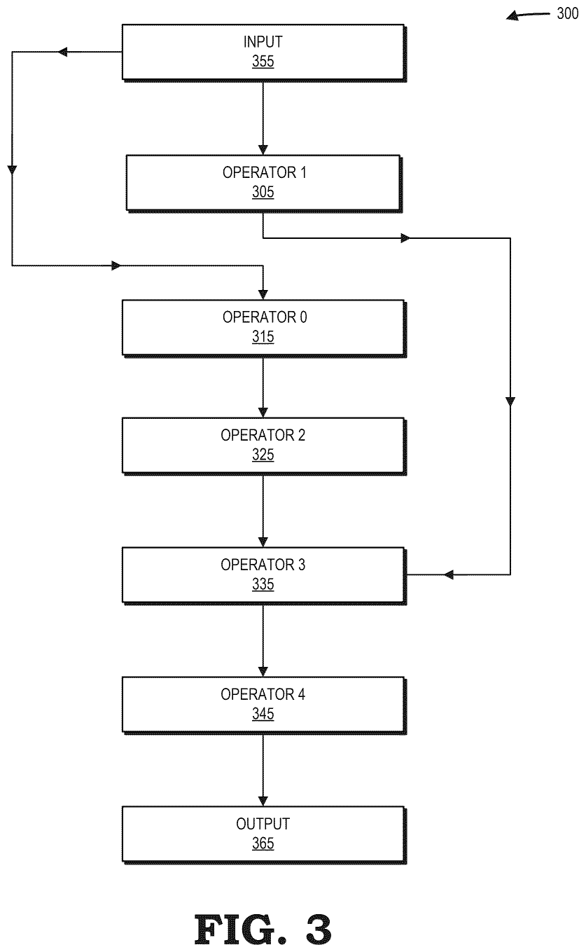

From the example operator group 275, CPU 102 generates a series of nodes 125. For example, based on how outputs of certain operators within the example operator group 275 are provided to other operators within the example operator group 275, CPU 102 sorts the operators of the example operator group 275 into a linear series of nodes 125. As an example, referring now to FIG. 3, an example series of nodes 300 generated from a corresponding operator group is presented, in accordance with implementations. In implementations, example series of nodes 300 is implemented in processing system 100 as a series of nodes 125. Example series of nodes 300 includes data indicating one or more inputs 355 provided to the series of nodes; nodes 305, 315, 325, 335, 345 arranged in a linear series that indicates the order in which the nodes are to be executed by AU 110; and the output 365 of the example series of nodes 300. Though the example implementation provided in FIG. 3 presents example series of nodes 300 as including six nodes 305, 315, 325, 335, 345, in other implementations, a series of nodes 125, 300 can include any non-zero integer number of nodes. For example, each series of nodes 125, 300 may have a number of nodes equal to the number of operators in the operator group 116 used to generate the series of nodes 125, 300.

Within the example implementation presented in FIG. 3, example series of nodes 300 is generated by CPU 102 based on example operator group 275. For example, based on example operator group 275, example series of nodes 300 first indicates one or more inputs 355 that each correspond to the inputs 255 of example operator group 275. Further, based on how outputs of certain operators within the example operator group 275 are provided to other operators within the example operator group 275, example series of nodes 300 includes a first node 305 that represents the second operator 215 of example operator group 275. This first node 305 is arranged so as to receive input 355 as an input and provide an output to a fourth node 335 in the series. Further, example series of nodes 300 includes a second node 315 representing the first operator 205 of example operator group 275 and arranged so as to receive input 355 as an input and provide an output to a third node 325. This third node 325, for example, represents the third operator 225 of the example operator group 275 and is arranged to receive the output of the second node 315 as an input and provide an output to the fourth node 335. Within example series of nodes 300, the fourth node 335 represents the fourth operator 235 of the example operator group 275 and is arranged to receive the output of the first node 305 and the output of the third node 325 as inputs and provide an output to a fifth node 345. The fifth node 345, as an example, represents the fifth operator 245 of the example operator group 275 and is arranged to receive the output of the fourth node 335 as an input and provide an output 365 of the example series of nodes 300. This output 365, for example, corresponds to the output 265 of example operator group 275.

Referring again to FIG. 2, after CPU 102 determines a series of nodes 125 (e.g., example series of nodes 300) from example operator group 275, example operation 200 includes CPU 102 generating operator group metadata 122 based on the determined series of nodes 125. For example, based on the operators represented by the nodes (e.g., nodes 305, 315, 325, 335, 345) of a series of nodes 125, CPU 102 generates operator group metadata 122 indicating an operator list 236, buffer mappings (e.g., buffer offsets, buffer sizes) for the operators in example operator group 275, data types used by the operators in example operator group 275, or any combination thereof. Such an operator list 236, for example, includes data listing each operator within the example operator group 275. For example, operator list 236 includes data indicating the first operator 205, second operator 215, third operator 225, fourth operator 235, and fifth operator 245 of example operator group 275. Within example operation 200, for each operator indicated in the operator list 236, CPU 102 retrieves a corresponding hardware-modified operator 132 from operator library 130 in memory 106. Each retrieved hardware-modified operator 132, for example, includes program code representing a precompiled operator previously modified to increase the performance of the operator on the hardware of AU 110. As an example, a hardware-modified operator 132 includes program code representing a precompiled operator that was previously modified to decrease the power consumption of the operator when executed by AU 110, decrease the time needed for AU 110 to execute the operator, decrease the memory footprint of the operator on AU 110, increase the processing efficiency of the operator when executed by AU 110, or any combination thereof. Based on the operator group metadata 122 determined for the example operator group 275 and for each retrieved hardware-modified operator 132, AU 110 determines one or more corresponding operator requirements 124 indicating a buffer size for performing the operation.

According to implementations, example operation 200 further includes CPU 102 generating a launch kernel 128 based on the series of nodes 125, operator requirements 124, or both. For example, CPU 102 first modifies the inputs of one or more retrieved hardware-modified operators 132 to point to the outputs of one or more other hardware-modified operators 132 based on the arrangement of corresponding nodes within the series of nodes 125. As an example, based on example series of nodes 300, CPU 102 modifies the inputs of the fourth operator 235, corresponding to the fourth node 335, to point to the outputs of the second operator 215, corresponding to the first node 305, and the third operator 225, corresponding to the third node 325. As another example, CPU 102 modifies the inputs of the third operator 225, corresponding to the third node 325, to point to the output of the first operator, corresponding to the second node 315. After modifying the inputs of one or more hardware-modified operators 132, CPU 102 then modifies the buffer offsets indicated by one or more hardware-modified operators 132 to ensure that that any modified inputs of the hardware-modified operators 132 point to corresponding outputs of other hardware-modified operators 132. Further, according to some implementations, CPU 102 modifies the buffer offsets of one or more hardware-modified operators 124 to enable memory reuse such that an address in a buffer 108 is used to store intermediate results, final results, or both of multiple hardware-modified operators 124, reducing the memory footprint of a resulting launch kernel 128.

Based on the modified hardware-modified operators 124 and corresponding operator requirements 124, CPU 102 generates a launch kernel 128. For example, after modifying the hardware-modified operators 124 and based on corresponding operator requirements 124, CPU 102 determines, for each node of the series of nodes 125, one or more instructions representing a corresponding hardware-modified operator 124 (e.g., as modified by CPU 102) and buffer sizes for the corresponding hardware-modified operator 124. After determining one or more instructions for each node, CPU 102 merges and serializes the instructions to produce a launch kernel 128 that includes a series of instructions 126. This series of instructions 126, for example, includes instructions that, when executed by AU 110, cause AU 110 to execute each operator in example operator group 275 based on corresponding inputs 255 to produce a corresponding output 265.

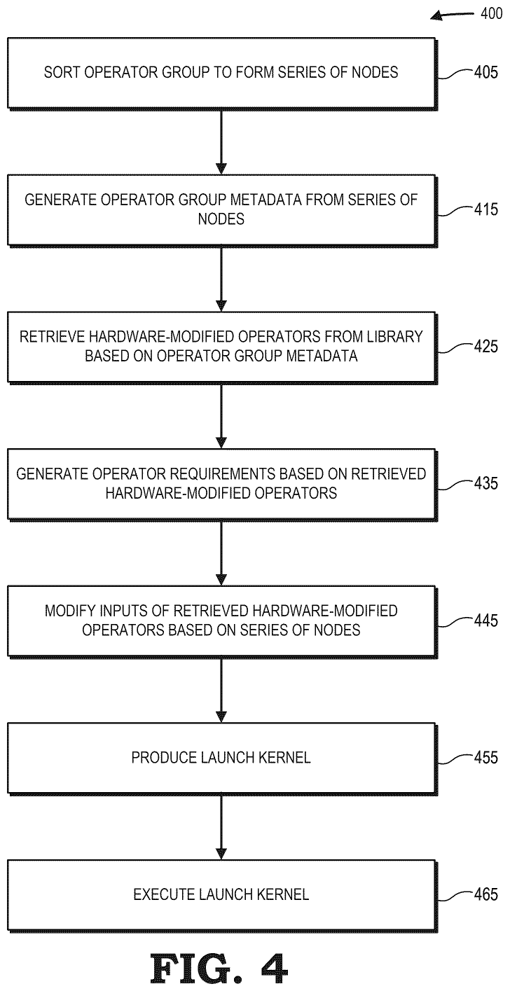

Referring now to FIG. 4, an example method 400 for generating and executing a launch kernel in a dynamic operator dispatch mode is presented, in accordance with some implementations. In implementations, at least a portion of example method 400 is implemented by CPU 102. At block 405 of example method 400, CPU 102, using a dynamic operator dispatch mode 120, receives an operator group 116 for a trained machine-learning model 114 to be implemented. Such an operator group 116, for example, includes data indicating one or more operators (e.g., operators 205, 215, 225, 235, 245) to be performed for the trained machine-learning model 114, inputs to each operator, outputs of each operator, or any combination thereof. Based on the received operator group 116, CPU 102 generates a corresponding series of nodes 125. For example, based on the inputs to each operator and outputs of each operator indicated in the operator group 116, CPU 102 generates a linear series of nodes 125 having a node for each operator indicated in the operator group 116. Based on the series of nodes 125, at block 415, CPU 102 generates operator group metadata 122 for the operators indicated in the operator group 116. As an example, based on the operators represented by each node in the series of nodes, CPU 102 generators operator group metadata 122 indicating a list of the operators (e.g., operator list 236), buffer mappings for the operators, data types used by the operators, or any combination thereof in the operator group 116.

After generating the operator group metadata 122, at block 425, CPU 102 retrieves one or more hardware-modified operators 132 from operator library 130 in memory 106. For example, for each operator in the list of the operators indicated in the operator group metadata 122, CPU 102 retrieves a corresponding hardware-modified operator 132 from operator library 130. Each hardware-modified operator 132 includes program code representing a precompiled operator that was previously modified to decrease the power consumption of the operator when executed by AU 110, decrease the time needed for AU 110 to execute the operator, decrease the memory footprint of the operator on AU 110, increase the processing efficiency of the operator when executed by AU 110, or any combination thereof. At block 435, CPU 102 is configured to generate operator requirements 124 for the retrieved hardware-modified operators 132. For example, based on the program code of each hardware-modified operator 132, CPU 102 generates operator requirements 124 indicating the buffer sizes used for the operands of the hardware-modified operator 132, instructions associated with (e.g., used to execute) the hardware-modified operator 132, or both. At block 445, after generating operator requirements 124, CPU 102 modifies one or more inputs of one or more retrieved hardware-modified operators 132 based on the series of nodes 125. That is, based on the arrangement of nodes within the series of nodes 125, CPU 102 modifies one or more inputs of a retrieved hardware-modified operator 132 to point to corresponding outputs of one or more other retrieved hardware-modified operators 132. As an example, based on the series of nodes 125 including a first node that provides an output to a second node as an input, CPU 102 modifies an input of the retrieved hardware-modified operator 132 associated with the second node to point to the output of the retrieved hardware-modified associated with the first node. Additionally, still referring to block 445, CPU 102 is configured to modify the buffer offsets of one or more retrieved hardware-modified operators 132 to ensure that the modified inputs of one or more retrieved hardware-modified operators 132 point to corresponding outputs of one or more other retrieved hardware-modified operators 132. Further, according to some implementations, at block 445, CPU 102 modifies the buffer offsets of one or more retrieved hardware-modified operators 124 to enable memory reuse such that an address in a buffer 108 is used to store intermediate results, final results, or both of multiple hardware-modified operators 124.

Referring now to block 455, after modifying the inputs, buffer offsets, or both of one or more retrieved hardware-modified operators 132, CPU 102 is configured to generate a launch kernel 128 based on the series of nodes 125, operator group metadata 122, operator requirements 124, or any combination thereof. For example, based on the operator requirements 124 for each retrieved hardware-modified operator 132, CPU 102 determines one or more instructions indicating the buffer sizes for the hardware-modified operator 132, buffer offsets for the hardware-modified operator 132, data (e.g., operands, variables, look-up tables, register files) used to perform the hardware-modified operator 132, or any combination thereof. After generating one or more instructions for each retrieved hardware-modified operator 132, CPU 102 then merges the instructions to produce a launch kernel 128 including a series of instructions 126 based on the series of nodes 125. For example, CPU 102 merges the generated instructions to form the series of instructions 126 such the series of instructions 126, when executed, causes the hardware-modified operators 132 to be executed in an order based on the series of nodes 125 (e.g., as indicated by the nodes of the series of nodes 125). At block 465, CPU 102 is configured to execute launch kernel 128 by first allocating buffers 108 to AU 110 based on the buffer sizes for the hardware-modified operators 132 indicated in the series of instructions 126. CPU 102 then stores the data)used to perform the hardware-modified operators 132 as indicated by the series of instructions 126 in the allocated buffers 108 based on the buffer offsets indicated in the series of instructions 126. After storing the data in the allocated buffers 108, CPU 102 provides the series of instructions 126 to AU 110 which, in turn, executes the series of instructions 126 and stores the data resulting from the execution of the series of instructions 126 in an allocated buffer 108 (e.g., output buffer) based on the buffer offsets indicated in the series of instructions 126. AU 110 then provides an interrupt to CPU 102 indicating that the results are ready to be read.

In some implementations, the apparatus and techniques described above are implemented in a system including one or more integrated circuit (IC) devices (also referred to as integrated circuit packages or microchips), such as the CPU 102 described above with reference to FIGS. 1-4. Electronic design automation (EDA) and computer-aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer-readable storage medium may include any non-transitory storage medium, or combination of non-transitory storage media, accessible by a computer system during use to provide instructions and/or data to the computer system. Such storage media can include but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some implementations, certain aspects of the techniques described above may implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM) or other non-volatile memory device or devices, and the like. The executable instructions stored on the non-transitory computer-readable storage medium may be in source code, assembly language code, object code, or another instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. A processing system comprising:
a memory configured to store an operator library; and
a processing unit comprising one or more processor cores configured to:
retrieve a plurality of operators from the operator library based on an operator group of a machine-learning model to be performed;
modify one or more operators of the plurality of operators based on the operator group; and
generate a launch kernel based on the modified one or more operators.

2. The processing system of claim 1, wherein the one or more processor cores are configured to:
generate a series of nodes based on the operator group, wherein each node of the series of nodes corresponds to a corresponding operator of the plurality of operators.

3. The processing system of claim 2, wherein the one or more processor cores are configured to:
generate an operator list including the plurality of operators based on the series of nodes.

4. The processing system of claim 2, wherein the one or more processor cores are configured to:
modify one or more inputs of an operator of the plurality of operators based on the series of nodes.

5. The processing system of claim 1, wherein the one or more processor cores are configured to:
for each operator in the plurality of operators, determine a corresponding buffer size, wherein the launch kernel is further based on the corresponding buffer size for each operator in the plurality of operators.

6. The processing system of claim 1, further comprising:
an accelerator unit configured to perform the modified one or more operators based on the launch kernel.

7. The processing system of claim 6, wherein each operator in the operator library is modified based on hardware of the accelerator unit.

8. A method comprising:
retrieving a plurality of operators from an operator library based on an operator group of a machine-learning model to be performed;
modifying one or more operators of the plurality of operators based on the operator group;
generating a series of instructions based on the modified one or more operators; and
providing the series of instructions to an accelerator unit for execution.

9. The method of claim 8, further comprising:
generating a series of nodes based on the operator group, wherein each node of the series of nodes corresponds to a corresponding operator of the plurality of operators.

10. The method of claim 9, further comprising:
generating a operator list including the plurality of operators based on the series of nodes.

11. The method of claim 9, further comprising:
modifying one or more inputs of an operator of the plurality of operators based on the series of nodes.

12. The method of claim 8, further comprising:
for each operator in the plurality of operators, determining a corresponding buffer size, wherein the series of instructions is further based on the corresponding buffer size for each operator in the plurality of operators.

13. The method of claim 8, further comprising:
performing, by the accelerator unit, the plurality of operators based on the series of instructions.

14. The method of claim 8, wherein each operator in the operator library is modified based on hardware of the accelerator unit.

15. A processing system, comprising:
a memory configured to store an operator library;
an accelerator unit; and
a processing unit including one or more processor cores configured to:
retrieve a plurality of operators from the operator library based on an operator group of a machine-learning model to be performed;
modify an input of one or more operators of the plurality of operators based on the operator group;
generate a series of instructions based on the one or more operators; and
provide the series of instructions to the accelerator unit for execution.

16. The processing system of claim 15, wherein the one or more processor cores are configured to:
allocate one or more buffers of the memory to the accelerator unit based on the series of instructions.

17. The processing unit of claim 15, wherein the one or more processor cores are configured to modify the input of the one or more operators to point to an output of another operator of the plurality of operators.

18. The processing system of claim 15, wherein the one or more processor cores are configured to:
generate a series of nodes based on the operator group, wherein each node of the series of nodes corresponds to a corresponding operator of the plurality of operators.

19. The processing system of claim 18, wherein the one or more processor cores are configured to:
generate an operator list including the plurality of operators based on the series of nodes.

20. The processing system of claim 15, wherein each operator in the operator library is modified based on hardware of the accelerator unit.
